(19) United States
(12) Patent Application Publication
(10) Pub. No.: US 2003/0004599 A1
(43) Pub. Date: Jan. 2, 2003

(54) Method of model construction

(76) Inventor: Zsolt Herbak, Wildbad-Calmbach (DE)

Correspondence Address: RABIN & CHAMPAGNE, PC, 1101 14TH STREET, NW, SUITE 500, WASHINGTON, DC, 20005, US

(21) Appl. No.: 10/168,498

(22) PCT Filed: Dec. 9, 2000
(86) PCT No.: PCT/DE00/04387

(30) Foreign Application Priority Data
Dec. 31, 1999 (DE) 199 63 948.5

(51) Int. Cl. G06F 19/00

(52) U.S. Cl. 700/119; 700/98; 264/308

(57) ABSTRACT

With a model for creating a prototype (rapid prototyping), two components (A, B) are mixed inside a mixer (12) of a traversing application head and the resulting model-building mass is ejected from the nozzle (14) of the application head. As a result, the prototype is constructed in layers. The two components react with each other and increase in volume, so that the layers of the prototype can be relatively large, approximately 1-5 cm (FIG. 1).

### TECHNICAL FIELD

The invention relates to a method for creating a prototype, as defined in the preamble to claim 1.

### PRIOR ART

A plurality of so-called rapid prototyping methods of this type is known, all of which use a synthetic material for constructing a prototype in layers (e.g. see magazine “INDUSTRIEANZEIGER” [Industry Advertising Journal] 47-48/97, pp 52-64).

As a result of constantly decreasing product cycles, the rapid prototyping method increasingly gains in importance. The layer-type construction generally occurs fully automatic, wherein the control signals are gained from a 3-D CAD data set. Methods used so far are relatively slow and can be used only for small prototypes. Constructing prototypes with a volume in the order of magnitude starting at 1 m³ is practically impossible. As a result, large-volume prototypes such as automobile prototypes on a scale of 1:1 must still be constructed primarily with mechanical methods and with a correspondingly high expenditure in materials and costs.

### SUMMARY OF THE INVENTION

Starting with the prior art, it is the object of the invention to create a prototyping method, which permits the construction of large-volume prototypes, which are created at least essentially automatic.

This object is solved with a method having the features as defined in claim 1.

The prototype created with a method according to the invention is constructed in layers, using a synthetic material that increases in volume immediately prior to or following the application, or if applied with an application head, for example a PU (polyurethane) high-resistance foam.

### BRIEF DESCRIPTION OF THE FIGURES

The invention is explained in further detail in the following with the aid of drawings, which show in:

FIG. 1A device for realizing the method;

FIGS. 2a-d A first variant of the method;

FIGS. 3a-d A second variant of the method;

FIG. 4A mixing head for realizing the method in a first operating position;

FIG. 5A mixing head for realizing the method in a second operating position;

FIG. 6A detailed view of the mixing head.

### DETAILED DESCRIPTION OF PREFERRED EMBODIMENTS

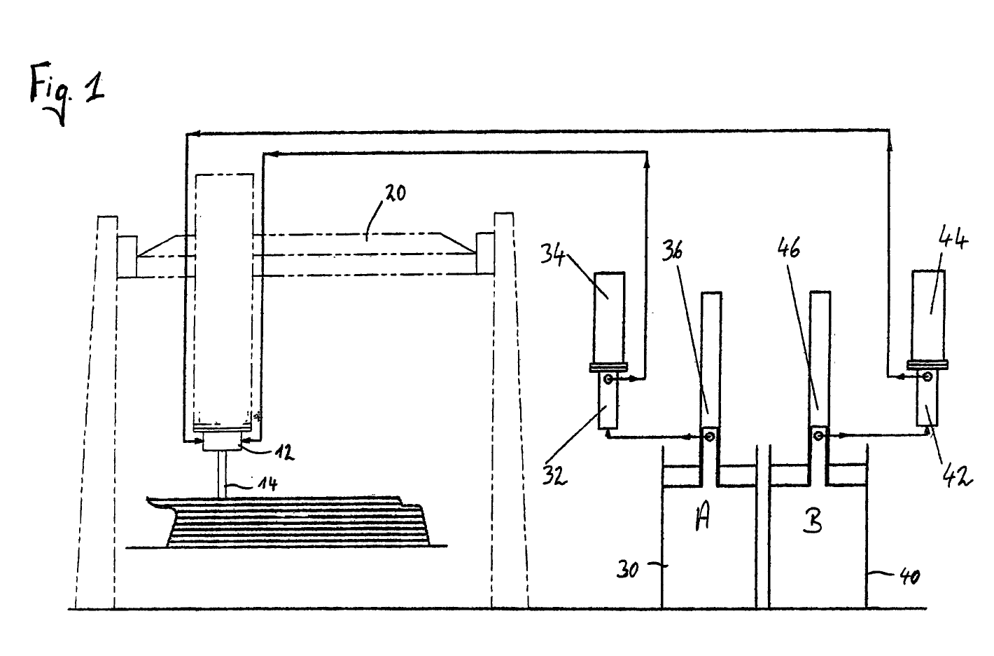

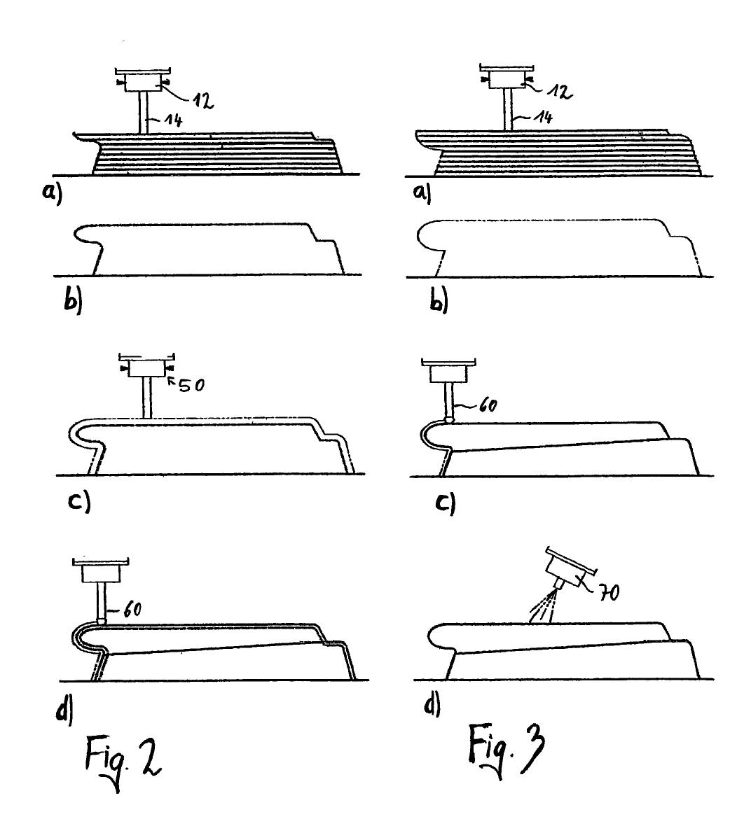

FIG. 1 shows a device for realizing the method according to the invention. The device is provided with an application head attached to an overhead gantry 20. The application head 10 consists of a mixer 12 with a nozzle 14. A suitable mixer/nozzle unit is described in the following with reference to FIGS. 4 to 6.

Two components A and B, respectively located inside tanks 30, 40, are initially conveyed with the two low-pressure conveying systems 36, 46 to the two high-pressure pumps 32, 42. The high-pressure pumps 32, 42, which are driven with the aid of two servomotors 34, 44 via electromagnetic linear units and which operate based on the double-action piston-pump principle, pump the components with a system pressure of 100-200 bar to the mixer 12. The delivery pressure level is detected with the aid of pressure sensors and the values transmitted to the central computer. The pulsation in the connected lines is smoothed by means of nitrogen bubbles.

The components are mixed inside the mixer 12 and exit through the nozzle 14. The components A and B react chemically, which leads to a volume increase of the substance. The application head traverses all three spatial directions, so that a prototype is built up in layers. The foam formed with the two components A and B achieves its final volume so rapidly and develops such a high starting rigidity that for each passage of the application head a new layer can be deposited on the previously created foam layer. The thickness of each foam layer in this case is approximately between 1 and 5 cm. A central computer controls the complete system, wherein the control signals are generated from a CAD data set. It is important that the mixing head movement on its spatial curve is synchronized with the pumping capacity of the high-pressure pumps 32, 42. For an exact control of the respective amounts to be pumped and thus also the mixing ratio of the two high-pressure pumps 32, 42, it is recommended that the pumps be operated with servomotors 34, 44. The characteristics of the foam can also be changed during the prototype production through an exact control of the mixing ratio.

For example, the following operational parameters are possible:

MDI (isocyanate) serves as component A and a polyol mixture with additives serves as component B. For example, the following formulation can be used:

| Product name/Manufacturer | Weight shares |
|---|---|
| Component A | |
| Desmodur VL/Bayer | 134.50 |
| Component B | |
| Desmophen 250 U/Bayer | 9.00 |
| Desmophen 550 U/Bayer | 35.50 |
| EW-Pol 1100/III./Henkel | 10.00 |
| castor oil/Graf | 20.00 |
| DAMP Fyrol 6/Akzo | 5.00 |
| APPO Fyrol 51/Akzo | 5.00 |
| Exolit TP 622/Hoechst | 12.00 |
| Martinal ON-920/Martinswerke | 26.00 |
| Additive DT/Bayer | 2.00 |
| Dabco/Goldschmidt | 6.00 |
| Fomrez UL 1/Witco NRC. | 0.80 |
| Tegostab B 8408/Goldschmidt | 1.20 |
| Topanol O/ICI | 2.00 |
| Hostaflamm RP 602/Hoechst | 6.00 |
| Filler material: titanium dioxide (optional) | 5-15 |
| Filler material: zinc oxide (optional) | 5-15 |

The actual chemical reaction then occurs in the mixer 12 with a potlife of approximately 10 seconds.

For one particularly advantageous embodiment, the arrangement comprises a measuring system, which controls the form of the already produced prototype part. Through feedback to the central computer, deviations from the desired value can thus be corrected during subsequent passages, for example by changing the mixing ratio for components A and B or by changing the speed of the application head.

In most application cases, the outside dimensions of a prototype, produced exclusively with the above-described method, are not exact enough. In addition, a smooth, hard surface that can be lacquered is frequently required, which cannot be produced with the foaming method. For that reason, two methods are suggested for the finishing work on the prototype.

With the first method (see FIG. 2), the basic prototype is initially finished as undersized model (Figures a), b)). In a second step, a synthetic material that is generally a two-component plastic is deposited on the basic prototype with a second application head 50. As a rule, this second application head 50 must operate with three linear and two rotational axes. Since it is probably difficult to deposit the synthetic material in such a way that an exact outside dimension results, it is recommended that the synthetic material be applied with excess dimensions and be cut down to the desired dimensions, following the curing of the synthetic material. A cutter head 60 used for this can also be CNC controlled and generally must operate with 5 axes. All operations can conceivably be realized with the same overhead gantry, wherein only the operating heads are replaced.

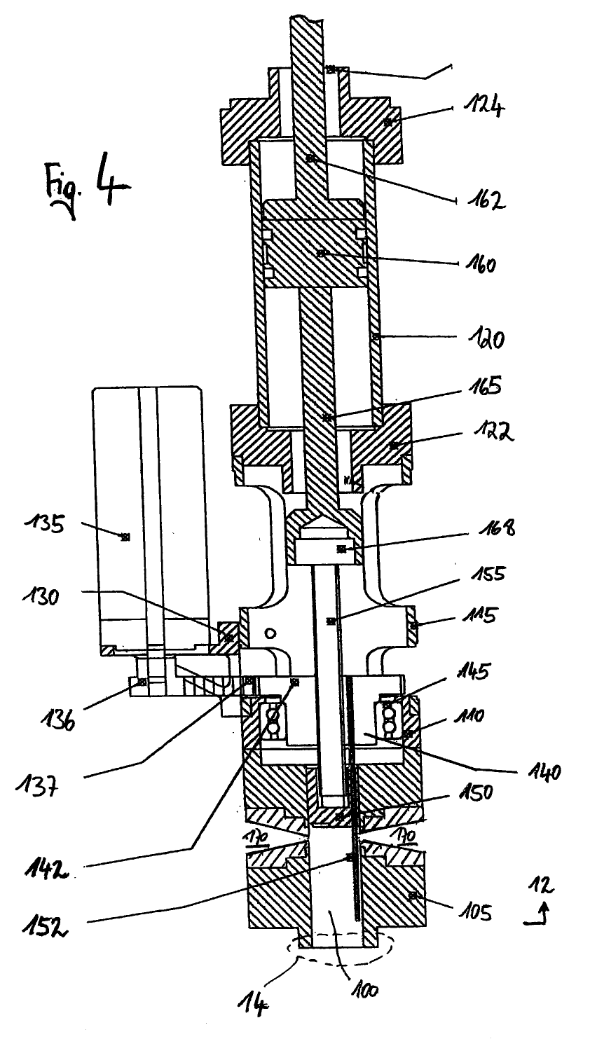

With a second method (see FIG. 3), the basic prototype is first produced as oversized model. Subsequently, this basic prototype is cut down to the desired dimensions with a cutter head 60. To obtain a hard surface, a two-component synthetic material is then deposited with a spraying head 70.

It is furthermore suggested that an intermediate layer be inserted between the layers of the prototype, for example an aluminum sheet or a foil. Intermediate layers of this type can be smooth, perforated or perforated and interlaced—for example a rib mesh. Individual sheet metal sheets/foils of this type are placed onto the top layer following each “passage” of the application head. This can be done by hand or by means of a robot. Intermediate layers of this type have the advantage that they can absorb tensile forces and thus can stabilize the prototype. Whether and how many such intermediate layers are necessary or desirable depends among other things on the size of the prototype and the material selection.

A suitable application head is described in the following:

A suitable mixing head is shown in the cross-sectional representation in FIG. 4. Mixer 12 and nozzle 14 in this case form a single structural. A mixing-chamber housing 105 has a cylindrical mixing chamber 100, which is open toward the bottom and thus forms the nozzle 14. The piston 150 is positioned so as to be axially displaceable inside the mixing chamber housing 105. The hydraulic piston 160 that is positioned inside the hydraulic cylinder 120 effects the axial displacement of the piston 150. The hydraulic piston 160 is rigidly connected to the hydraulic rod 165, which caries the first ball bearing 168 on its lower end. The splined shaft 155 is held on the inner raceway for the ball bearing 168, so that the hydraulic rod 165 and the splined shaft 155 are axially coupled, but are not connected with respect to the rotation around axis A-A. The splined shaft 155 penetrates the coupling element 140. As a result, the coupling element 140 and the splined shaft 155 are connected for their rotational movement. The piston 150 that is arranged inside the mixing chamber 100 is attached to the end of the splined shaft 155. The above-mentioned coupling element 140 is connected via the second ball bearing 145 to the bearing flange 110, which in turn is rigidly flanged to the mixing chamber housing 105. The coupling element 140 has an essentially symmetrical design with respect to the axis A-A and carries the gear rim 142 on the outside. The motor 135 can be used to drive the gear rim 142 and thus also the coupling element 140. The gear wheel 136 is arranged on the shaft of motor 135, which in turn is connected by means of the toothed belt 137 to the gear rim 142. The motor 135 is flanged via the console 130 to the lantern 115 or the bearing flange 110.

The stirring rod 152, which extends parallel to axis A-A inside the mixing chamber 100, is arranged on the coupling element 140 and extends through the piston 150.

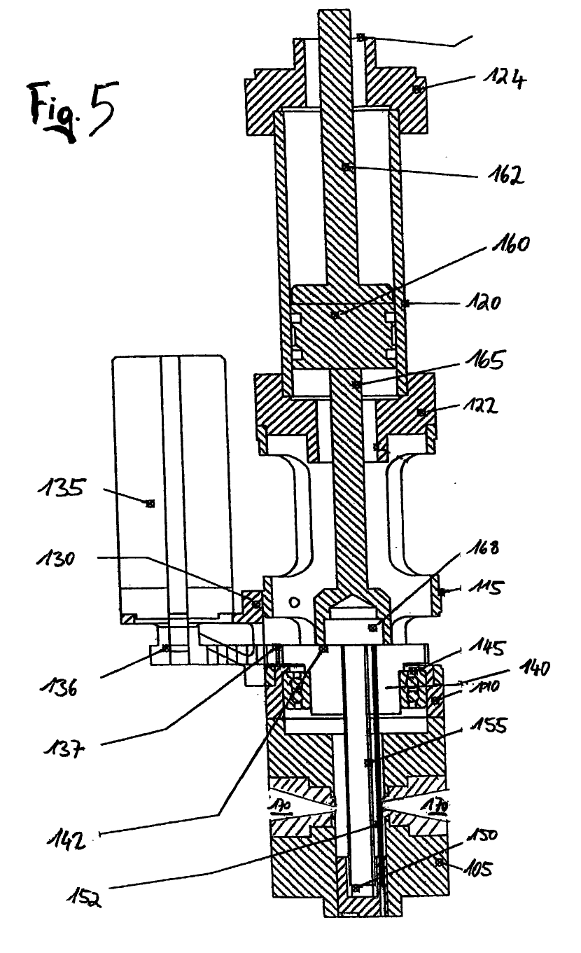

The two nozzles 170 are arranged inside the mixing chamber housing 105. The viscous liquids to be mixed are pushed through these nozzles into the mixing chamber 100. The two nozzles 170 are shown only schematically in FIGS. 4 and 5.

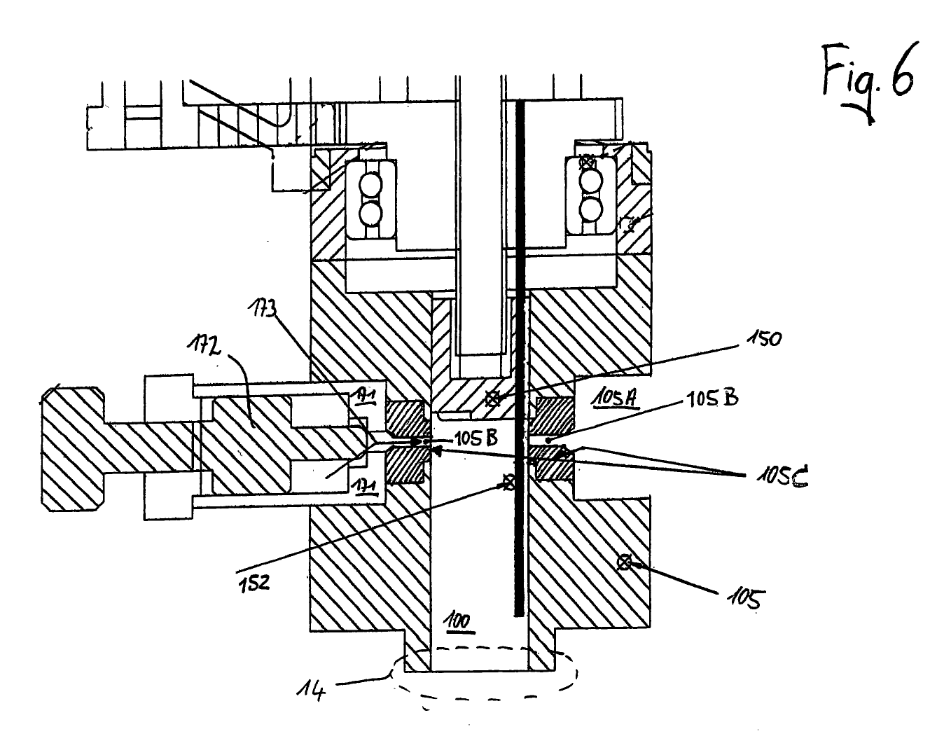

FIG. 6 shows a design option for these nozzles 170. The mixing chamber housing 105 is provided with two recesses 105A, into which respectively one nozzle body 171 is inserted (shown is only one nozzle body 171 herein). Inside of the nozzle body 171, the externally built-up high pressure (see above) is adjusted by means of an injection piston 172 and the liquid is pushed through the nozzle body opening 173 from the nozzle body 172. Arrangements of this type are known in the technical field and will not be described further herein. The actual nozzle openings in this case are the exit bores 105B in the hardened nozzle tips 105C in mixing-chamber housing 105. The nozzle bodies can also conceivably be extended up to the mixing chamber, so that the front of the nozzle body forms a component of the side wall of the mixing chamber. In that case, the nozzle-body opening and the exit bore in the nozzle tip would be identical.

The principal mode of operation for the mixer is described in the following:

The first operating position of the device is shown in FIG. 4. In that case, the piston 150 is located above the nozzle openings for nozzles 170. In this position, the liquids to be mixed are injected through the nozzles 170 into the mixing chamber 100. The injecting occurs normally under high pressure, meaning with injection pressures above 100 bar. During the injection operation, the coupling element 140 and thus also the piston 150 and the stirring rod 152 are rotated with the aid of motor 135. Even highly viscous liquids can be mixed as a result of the rotation of piston 150 and the stirring rod 152. The mixed-together liquids exit at the lower end of mixing chamber 100.

Following the completion of the mixing operation, the supply of the two liquids through the nozzles 170 is shut down. Subsequently, the piston 150 is pushed axially downward inside the mixing chamber 100 (see FIG. 5) through pressure applied by the hydraulic piston 160. The remaining residues are thus pushed out of the mixing chamber 100 and the mixing chamber 100 is cleaned. At the same time, the stirring rod 152 is scraped off and thus cleaned. If the production is to be restarted, then piston 150 is pulled back to the position shown in FIG. 1 and the cycle can restart.

The automatic cleaning function described herein ensures that the mixer/nozzle unit can be cleaned easily during each interruption in the production, for example for inserting an intermediate layer (see above), which is extremely important with quick-hardening PU foam, such as the one used for this example.

1. A method for creating a prototype by using a model-building mass, which is deposited with an application head in layers onto a base,
characterized in that a model-building mass is used, for which the volume increases immediately prior to, during or following the exit from the traversing application head.

2. A method according to claim 1, characterized in that a synthetic material is used as model-building mass, for which the volume increases under the effect of air.

3. A method according to claim 2, characterized in that a synthetic material is used as model-building mass, which consists of at least two components (A, B) that react immediately prior, during and/or after the mixing operation and immediately prior to the application, so as to increase in volume.

4. A method according to claim 1, characterized in that the operating path for the application head traversing in three spatial direction is created by converting the geometric data from a predetermined, concrete or virtual prototype design into control signals for a drive unit of the application head.

5. A method according to claim 4, characterized in that a 3D-CAD data set is used as geometric data for the prototype design.

6. A method according to claim 4 and 5, characterized in that this CAD data set is converted to a set of control signals, which are processed successively by the drive unit and are worked off by the application head.

7. A method according to claims 4-6, characterized in that three-dimensional space information for the resulting prototype, particularly the thickness of the respectively created layer following the volume increase is detected with sensors and is computed with the control signals in the form of regulation variables or correction signals.

8. A method according to claims 1-7, characterized in that the model-building mass is applied in horizontal layers.

9. A method according to claims 4-8, characterized in that the control signal set is generated from the CAD data set and, if necessary, from the correction signals, such that the application parameters for the application head and the movement of its drive unit result in an essentially constant layer thickness of the synthetic material at the end of the volume increase.

10. A method according to claim 9, characterized in that the layer thickness is selected to be between 1 and 5 cm.

11. A method according to the preceding claims, characterized by its use for creating a prototype in the original size (scale 1:1) that is planned for realizing the prototype design.

12. A method according to claim 11, characterized by its use for creating automobile prototypes.

13. A method according to claim 1 or 11, characterized in that the control signal set is generated from the 3D-CAD data, in such a way that a prototype with homogeneous density is created.

14. A method according to claim 1 or 11, characterized in that the control signal set is generated from the 3D-CAD data, such that a prototype with homogeneous core region and an at least partially surrounding shell region is created, the density of which deviates from the density of the core region and, in particular, is selected to be larger.

15. A method according to claim 8, characterized in that the prototype is created in dependence on the layer structure either undersized or oversized and is finished in a subsequent operational step.

16. A method according to claim 15, characterized in that coating, smoothing or cutting operations are used for the finishing operations.

17. A method according to claim 1, characterized in that the prototype is created in at least two sections, in which different model-building masses are used.

18. A method according to claim 16 or 17, characterized in that the application head is exchanged against a finishing tool or another application head in order to realize the finishing operation or for changing the model-building mass.

19. A method for realizing the method according to claim 8-18, characterized by an overhead gantry (20) as drive unit for the application head and/or the finishing tools.

20. A method according to one of the preceding claims, characterized in that sheet metal sheets or foils are inserted between the layers of the model-building mass.

21. A device for realizing the method according to claim 1, characterized in that the application head is provided with a nozzle (12) and a mixer (14).

22. A device according to claim 20, characterized in that two injection pumps (32, 42) are connected to the mixer (14).

23. A device according to claim 21, characterized in that the injection pumps (32, 42) are driven by servomotors (34, 44).
